(19) United States
(12) Patent Application Publication
(10) Pub. No.: US 2024/0078784 A1
(43) Pub. Date: Mar. 7, 2024

(54) METHOD AND SYSTEM FOR PROCESSING IMAGE DATA

(71) Applicant: SeeChange Technologies Limited, Manchester (GB)

(72) Inventors: David Packwood, Leicester (GB); Ariel Edgar Ruiz-Garcia, Manchester (GB)

(21) Appl. No.: 18/272,858

(22) PCT Filed: Sep. 23, 2021
(86) PCT No.: PCT/GB2021/052474

§ 371 Date: Jul. 18, 2023

(30) Foreign Application Priority Data
Dec. 31, 2020 (GB) 20 20828.6

(51) Int. Cl. G06V 10/426; G06T 3/40; G06V 10/44; G06V 10/82

(52) U.S. Cl. CPC G06V 10/426; G06T 3/40; G06V 10/44; G06V 10/82; G06V 2201/07

(57) ABSTRACT

A computer implemented method of processing image data by an image processing system comprising a directed acyclic graph of nodes for receiving and processing image data is disclosed. The method comprises: at a compute node in the graph: receiving image data; performing an image processing operation on the image data to produce a compute node output based on the data; and transmitting the compute node output to another node in the graph. The method also comprises, at a control node in the graph: receiving a control node input, wherein the control node input is the image data or is based on the image data; and, if the control node determines that a control condition is satisfied, transmitting the control node input to another node in the graph. A computer implemented image processing system is also disclosed.

### TECHNICAL FIELD

The present invention relates to a computer implemented method and system for processing image data.

### BACKGROUND

The processing of images, for example to determine characteristics of a scene represented by the content of the images, is known. A stream of images, such as a video stream may, for example, be processed to identify features of the content of the images or other characteristics of the images or to process the image in any number of ways. For example, images may be analysed to determine characteristics of the content of the images, such as objects shown in the images and/or to make higher-level inferences about a scene represented by the content of the images. Such processing of image content has many uses. As one example, video from cameras may be analysed to recognize people shown by the video.

However, there are practical challenges to implementing such analysis of image content. For example, implementing a particular image analysis application may require a different approach depending on the hardware to be used to implement the application. Furthermore, modifying the way in which an image processing system processes images may be difficult and time consuming. Moreover, processing of images can be relatively computationally intensive and, in particular, where such processing needs to be conducted in real-time or near real-time and/or for a relatively high frame rate, this can compound the computational demands.

### SUMMARY

According to a first aspect of the present invention, there is provided a computer implemented method of processing image data by an image processing system comprising a directed acyclic graph of nodes for receiving and processing image data, the method comprising: at a compute node in the graph: receiving image data; performing an image processing operation on the image data to produce a compute node output based on the image data; and transmitting the compute node output to another node in the graph; and at a control node in the graph: receiving a control node input, wherein the control node input is the image data or is based on the image data; and, if the control node determines that a control condition is satisfied, transmitting the control node input to another node in the graph.

The image data may be data defining an image frame. The system may be for processing a stream of image frames, wherein the image frame is one of the stream of image frames.

The method may comprise: at the control node, transmitting an indicator indicative that the control condition was not satisfied to the other node in the graph if the control condition is not satisfied.

The compute node output may comprise the image data in combination with data indicative of a result of the image processing operation performed on the image data.

The image processing operation performed by the compute node may comprise analysing the image data to determine one or more characteristics of the image data. Analysing the compute node input may comprise applying a trained model to the image data to detect one or more features and/or recognise one or more objects of a scene represented by the content of the image data. The trained model may comprise a neural network.

Where the image data define an image frame, the image processing operation may be an image manipulation operation to be performed on the image frame, such as a resizing operation or a cropping operation.

The control condition may be determined based on a characteristic of the image data or a characteristic of the compute node output.

The control condition may be determined based on one or more of: a source identifier identifying a source of the image data; and where the image data define an image frame in a stream of image frames, a position of the image frame in the stream of image frames.

The other node to which the control node transmits the control node output if the control condition is satisfied may be one or more of: the compute node and/or another compute node; another control node; and an output node configured to output image processing data from the graph.

The other node to which the compute node transmits the compute node output may be one or more of: another compute node; the control node and/or another control node; and an output node configured to output image processing data from the graph.

The control node input may be the image data and the other node, to which the control node transmits the control node input if the control condition is satisfied, may be the compute node.

The method may comprise: at a second compute node in the graph: receiving the compute node output based on the image data as a second compute node input; performing an image processing operation on the second compute node input to produce a second compute node output based on the image data; and transmitting the second compute node output to another node in the graph.

The method may comprise: at the control node: receiving the compute node output as the control node input; and transmitting the compute node output to the second compute node as the second compute node input if the control condition is satisfied.

The method may comprise: at a second control node in the graph: receiving a second control node input, wherein the second control node input is the image data or is based on the image data; and transmitting the second control node input to another node in the graph if a second control condition is satisfied.

The method may comprise: at the control node: transmitting the control node input to the compute node, and at the second control node: receiving the compute node output as the second control node input.

The control node input may be the same as the second control node input.

The control node may be configured to determine to which one of a plurality of other nodes the image data is to be transmitted.

The image data may be first image data and the method performed by the system may comprise processing second image data concurrently with the first image data.

The concurrent processing may comprise processing the first image data by one of the nodes of the graph concurrently with processing the second image data by another node of the graph.

According to a second aspect of the present invention there is provided a computer implemented image processing system for processing image data, the system comprising a directed acyclic graph of nodes configured to receive image data and to process the image data, the directed acyclic graph of nodes comprising: a compute node configured to receive the image data, to perform an image processing operation on the image data to produce a compute node output based on the image data, and to transmit the compute node output to another node in the graph; and a control node configured to receive a control node input, wherein the control node input is the image data or is based on the image data, and to transmit the control node input to another node in the graph if a control condition is satisfied.

According to a third aspect of the present invention there is provided a computer implemented image processing system for processing image data, the system comprising a directed graph of nodes configured to process image data by passing the image data through the graph, the graph comprising: one or more compute nodes, each compute node configured to perform a respective image processing operation on image data received by the respective compute node and to output processed image data based on the image processing operation; and one or more control nodes, each control node configured to direct image data received by the respective control node to one or more other nodes in the graph based on a respective control condition.

According to a fourth aspect of the present invention there is provided an apparatus for processing image data, the apparatus comprising a computer implemented image processing system according to the second aspect or according to the third aspect.

According to a fifth aspect of the present invention there is provided a computer-readable medium comprising instructions which, when executed by a computer, cause the computer to perform the method according to the first aspect or to implement the system of the second aspect or the system of the third aspect.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a flowchart representation of a method for processing image frames according to an example,

FIG. 2 is a schematic diagram illustrating a system for processing image frames according to an example;

FIG. 3 is a schematic diagram illustrating another system for processing image frames according to an example;

FIG. 4 is a schematic diagram illustrating another system for processing image frames according to an example;

FIG. 5 is a schematic diagram illustrating a portion of a system for processing image frames according to an example;

FIG. 6 is a schematic diagram illustrating another portion of a system for processing image frames according to an example;

FIG. 7 is a schematic diagram illustrating another portion of a system for processing image frames according to an example;

FIG. 8 is a schematic diagram illustrating a computing system employing a method of processing image frames according to an example; and

FIG. 9 is a schematic diagram illustrating an apparatus for processing image frames according to an example.

### DETAILED DESCRIPTION

Certain examples described herein relate to an image processing system for processing image data, in some examples the image data defining an image frame in a stream of image frames, the system comprising a directed acyclic graph of nodes. Each of the nodes performs a function in the processing of images received to be processed by the graph. In this context, the graph is a computer program while a node is a functional block or component of the computer program. Each node is configured to receive an input and perform a function based on the input. A node may, for example, comprise a neural network model configured to receive one or more inputs and make inferences based on one or more received inputs. Different nodes may perform different functions, such as inputting image data, e.g. frames, to the graph, outputting image data from the graph, performing image processing operations on the image data, or directing image data along edges of the graph to other nodes in the graph based on certain conditions. Because the graph is directed, image data may enter at a source, or input node, of the graph and be egressed at a sink, or output node, of the graph. Due to the acyclic nature of the graph according to certain examples, processing of image data by the graph may be completed without instigating an interminable loop of processing functions.

According to examples described herein, a modular image processing system, or engine, is provided which is highly configurable by, for example, interchanging certain nodes of the graph or modifying the function of certain nodes. In particular, examples allow for image data to flow through the graph, being guided through the graph by one or more control nodes based on certain conditions, and being modified by the operation of compute nodes which are configured to perform image processing operations, such that processed image data, e.g. a processed frame, is output from the graph. Various advantages can be achieved by example systems due to their modular nature, including providing for interoperability of an image processing system having a particular function with different image processing hardware, and allowing for complex image processing topologies to be easily constructed and modified. Certain examples may provide for improved computational efficiency in an image processing system by virtue of the modular structure of example image processing systems. For example, the computational load placed on hardware configured to perform certain image processing functions may be reduced by efficiently directing the flow of image data through the graph according to the overall image processing task to be performed.

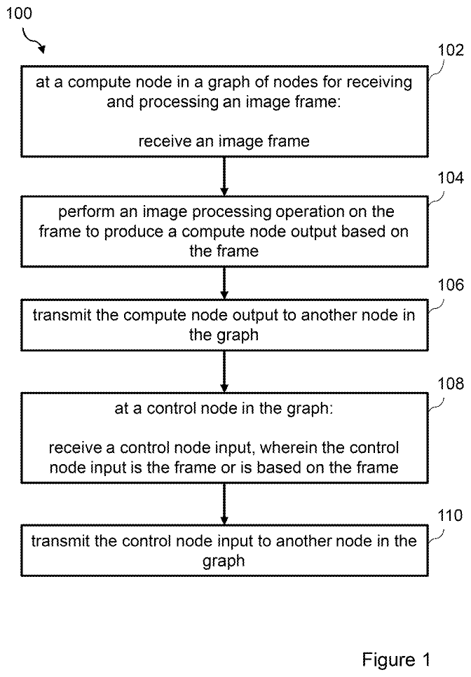

Various examples of image processing methods and systems according to the present disclosure will now be described, beginning with FIG. 1 which illustrates, in a flowchart representation, an image processing method 100 according to an example.

The method 100 is performed by an image processing system comprising a directed acyclic graph of nodes for receiving and processing an image frame.

The method 100 comprises at block 102, at a compute node in the graph, receiving an image frame. The image frame may a frame of a stream of image frames, for example, a frame of a video stream. The frame may be received at the compute node from an input node, which acts as a source of frames for the graph, from another compute node, or from a control node, as will be discussed in more detail below.

At block 104, the method 100 comprises performing an image processing operation on the frame to produce a compute node output based on the frame. The image processing operation performed by the compute node may, for example, comprise analysing the frame to determine one or more characteristics of the frame. The image processing operation may for example, comprise applying to the frame an artificial intelligence model, which may comprise a neural network model, and which can be trained so that inferences can be made on the basis of the frame. In some examples, the analysing of the compute node input may comprise applying a trained model to the frame to detect one or more features and/or recognise one or more objects of a scene represented by the content of the frame. For example, compute node may be configured to apply object recognition to an image to detect the presence and/or a class of any objects shown in the frame.

In some examples, a feature detection model may be applied to the frame to detect features of the content of the frame, for example to detect lines, edges, ridges, corners, blobs, textures, shapes, gradients, regions, boundaries, surfaces, volumes, colours and/or shadings. Object recognition may be achieved, for example, by applying a process of comparing stored representations of objects of interest to detected features and applying a matching rule for determining a match between the stored representations and the features. Such object recognition may utilise a data store of pre-specified objects when trying to identify an object represented by an image. For example, an object recognition model may group a set of detected features as a candidate object in a given scene and refer to the data store of pre-specified objects in order to identify the object. The detected features and/or objects may be used to infer information about the scene represented by content of the frame, such as spatial models, lists of objects, tracking of objects though space, estimation of the motion of objects, detection of events, and/or recognition of gestures.

The result of the image processing operation in some examples is a processed frame, for example a modified version of the frame. In another example, the result of the image processing operation is data which is determined by the image processing operation. For example, the image processing operation may comprise applying a model to the frame and producing as an output of the operation, data indicative of the result of the image processing operation. For example, the result of the image processing operation and the output of the compute node may comprise the frame in combination with metadata. In one example where the image processing operation is an object recognition operation, the output of the image processing operation comprises the frame along with metadata appended to the frame indicating objects determined to be present in the frame.

In other examples, the image processing operation is another type of operation performed on the frame. The image processing operation may be a utility operation, such as an image manipulation operation to be performed on the frame, for example, a resizing operation or a cropping operation.

At block 106 the method comprises transmitting the compute node output based on the frame to another node in the graph. The compute node may at block 106 transmit the compute node output to one or more other nodes in the graph. In one example, at block 106 the compute node transmits the compute node output to a control node. In another example, the other node in the graph to which the compute node transmits the compute node output is another compute node. For example, the compute node may transmit the compute node output to another compute node in the graph for the other compute node to apply another image processing operation to the input it receives. For example, the compute node output may comprise the frame with appended metadata indicative of persons detected in the frame and the other node may be configured to apply a facial recognition operation to any persons detected in the frame. In another example, at block 106 the compute node transmits the compute node output to an output node which is configured to output the result of the processing of the frame from the graph. The output node acts as a ‘sink’ for the graph.

In this example, at block 108, the method comprises receiving, at a control node in the graph, a control node input. The control node input may be the frame or may be based on the frame. At block 110, if the control node determines that a control condition is satisfied, the control node transmits the control node input to another node in the graph.

For example, where the compute node, at block 106, is configured to transmit the compute node output to a control node, at block 108 the control node may receive the compute node output based on the frame as the control node input. The control node may then proceed at block 110 to determine if the control condition is satisfied, and if so, to transmit the compute node output it received at block 108 to another node in the graph. In one particular example of this, the compute node output comprises the frame with appended metadata indicative of whether any persons were detected by the compute node to be present in the frame. In this example, at block 110, if the control node determines from the metadata appended to the frame that a person was detected in the frame, the control node transmits the frame and metadata to another node in the graph, e.g. a compute node configured to perform facial recognition on the frame. If the control node determines that the control condition is not satisfied, the control node does not transmit the frame to the other node. For example, in the above example, if the control node determines from the metadata appended to the frame that no persons are present in the frame, the control node does not transmit the frame to the facial recognition node. In another example, the control node may transmit the control node input based on the frame which it receives to an output node to be output from the graph.

The control condition, based on which the control node determines whether to send the control node input to another node, may be based on a characteristic of the frame it receives. For example, the control condition, based on which the control node determines whether to send the control node input to another node, may be based on one or more of: a position of the frame in the stream of image frames; a source identifier identifying a source of the frame; a characteristic of the frame, such as a characteristic of the frame determined by the compute node or another compute node.

In another example, at block the control node input received by the control node at block 108 may be received from the input node. In this case the control node input received by the control node is the frame received at the input of the graph. The control node at block 110 then determines if the control condition is satisfied and, if so, transmits the frame to another node in the graph. For example, the control node may determine if the control condition is satisfied to transmit the frame to a compute node. Accordingly, in some examples, the receiving of the frame at the control node at block 108 and the transmitting of the frame if the control condition is satisfied may occur before the receiving of the frame by the compute node at block 102 (and before the above-described processing and transmitting performed on the basis of the frame by the compute node).

In an example of this, the control node is configured to determine, based on a position of the frame in the stream of images, whether to transmit the frame to the compute node. For example, the control node may determine whether the control condition is satisfied based on the position of the frame in a sequence of temporally ordered frames to be analysed. For example, each frame may comprise a number, e.g. a time stamp, indicative of the position of the frame in a temporally ordered stream of images. The control node may determine if the frame is a first frame in the sequence, to transmit the frame to the compute node, and if the frame is a second frame in the sequence or a third frame in the sequence, not to transmit the frame to the compute node. In such an example, the control node may follow a predetermined pattern that is repeated for successive sequences of frames of the stream. As an example, a sequence of extracted video frames may comprise three successive frames, and if the given extracted frame is first in the sequence then control node may transmit the frame, whereas if the frame is the second or third in the sequence then the control node may determine that the control condition is not satisfied and may not transmit the frame to the compute node. This pattern may be repeated for successive sequences of frames such that, for example, every third frame is transmitted to the compute node for the compute node to be processed by the compute node. In other examples, the control node may be configured to transmit one of every two frames, or one of every five frames, for example.

Example systems may comprise any number of control nodes, for example, a first control node may receive a frame, or an input based on the frame, and transmit its output to a compute node if a first control condition is satisfied. The compute node may then process the frame or input it received based on the frame and transmit its output to a second control node. The second control node may then apply a second control condition and transmit the input it receives to another node, such as another compute node, the output node, or another control node, if the second control condition is satisfied.

In some examples, two or more control nodes are configured to receive the same input. The control nodes may apply different control conditions to the input they receive and thereby direct frames or inputs based on frames to different nodes in the graph. In examples, each node provides only one output for a given frame while a given node may receive more than one input in respect of a given frame. For example, a control node may receive two inputs and may determine which of the two inputs to transmit based on a control condition. In yet another example, a control node may be configured to transmit its output to another control node.

In examples, if the control node determines for a particular frame that the control condition is not satisfied, then the control node transmits an indicator indicative that the control condition was not met to another node in the graph. Nodes which receive such an indicator do not receive the frame data and may transmit the indicator to their output, for example, in the case of a compute node, without performing any image processing in respect of the frame being processed by the graph. Control nodes which receive such an indicator may similarly transmit the indicator to their output without evaluation their control condition. In examples, the indicator may comprise a null which indicates that the output in respect of the present frame being processed has no value. Accordingly, for example where the control node is configured to transmit its output to the compute node, if the control condition is satisfied, the compute node receives the frame and processes the frame, while if the control condition is not satisfied, the compute node receives an indicator, such as a null, and forwards the indicator to its output. The compute node therefore does not need to perform any discrimination between frames or determination of whether to process a given frame. Rather, if the control condition is not satisfied, the compute node does not receive the frame.

An image processing system having a modular and highly configurable nature may be provided by forming a directed acyclic graph of compute nodes and control nodes according to examples and causing frames to flow through the graph to be processed. Frames, or modified frames, may be guided through the graph by the operation of one or more control nodes which may act as ‘gates’ in the graph which transmit frames to other nodes in the graph based on control conditions. By use of such nodes, an image processing system having a desired function may be constructed in a simple and intuitive manner. Computational efficiency can be improved since, for example, compute nodes may receive only frames which they are to process and may perform substantially no work in respect of other frames. Examples of particular systems will be now be described with reference to the figures.

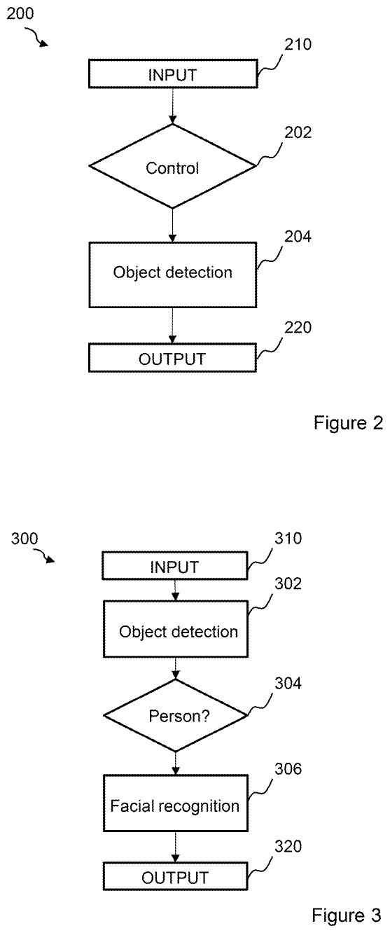

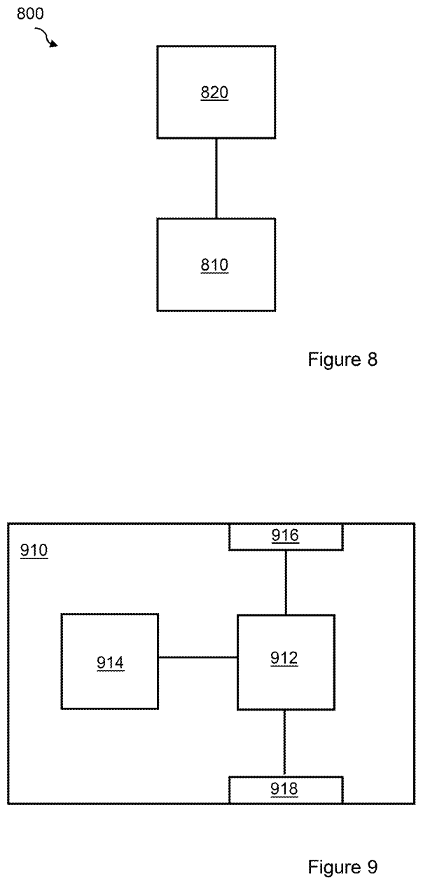

FIG. 2 shows a computer implemented image processing system 200 according to an example. The image processing system 200 comprises a directed acyclic graph of nodes 200 configured to process a stream of image frames. The image processing system 200 of FIG. 2 may, for example, be implemented in an image processing apparatus. A particular example of such an implementation for processing a stream of images received at an image processing apparatus from a camera will be described below with reference to FIG. 8.

The directed acyclic graph of nodes 200 comprises a plurality of nodes, each of which performs a function in the processing of the frames. In particular, the graph 200 of FIG. 2 comprises an input node 210, an output node 220, a control node 202 and a compute node 204. Briefly, the input node 210 is configured to receive frames of the stream of frames and to transmit each frame to one or more other nodes in the graph 200 to be processed. The output node 220 is configured to receive the result of the processing of frames by the graph 200. A result of the processing of the frames by the graph 200 is output at the output node 220.

In the example of FIG. 2, the input node 210 receives image frames to be processed by the system 200 and transmits those image frames to the control node 202. In this example, when the control node 202 receives an image frame, the control node 202 is configured to transmit the frame to the compute node 204 if the control node 202 determines that a control condition is satisfied.

For example, since object detection may be computationally expensive, in examples, it may be desired that not all of the frames of the stream of images are processed with the object detection model. For example, it may be desired to process only one in three frames in the stream of image frames. In order to achieve this, in the particular example of FIG. 2, the control node 202 is configured to transmit only a subset of the image frames it receives from the input node 210 to the compute node 204. In this example, the control node 204 is configured to determine a position of each frame it receives in the stream of images and to transmit only every third frame to the compute node 204. In this example, if the control node 202 determines that the control condition is not satisfied, the control node 202 does not transmit the frame to the compute node 204 but, instead, transmits a null to the compute node 204. If the compute node 204 receives a null from the control node 202, the compute node 204 performs no image processing in respect of the frame and simply transmits the null as the output of the compute node 204. If, on the other hand, for a particular frame, the control node 202 determines the control condition is satisfied, the compute node 204 receives the frame from the control node 202. Having received the frame, the compute node 204 performs an image processing operation on the frame.

In this example, the compute node 204 is an object detection node 204 which is configured, when it receives a frame, to apply a trained model to the frame and to output a processed frame comprising the original frame in combination with data indicative of objects in the frame by the model, along with the frame. As above, where the compute node 204 receives a null, it transmits the null via its output, and does not perform any object detection in respect of the frame being processed by the graph.

The compute node 204 transmits the output of the image processing operation performed on the frame, i.e. a processed version of the frame or a null, to another node in the graph. In this example, the compute node 204 transmits its output to the output node 220. In other examples, a compute node may instead transmit its output to another node other than the output node, e.g. another compute node, another control node or more than one compute and/or control node.

In the graph 200 of FIG. 2, once the output of compute node 204 in respect of the processing of a particular frame is received at the output node 220, the frame or a null has passed through each node in the graph 200, and the processing of the frame by the graph 200 is complete. The output of the image processing system 200 may, for example, be sent to be stored in a storage or sent to undergo further analysis, or, e.g. discarded if the output is a null. For example, the output of the system 200 may be sent to a logic apparatus configured to determine if the processing of the frames indicates that the content of the frames represents a given scenario, e.g. that the image stream represents a person scanning an item in a supermarket. In another example, the processed frames output by the graph may be stored, or, for example, sent for further processing, based on whether the metadata appended by the object detection node 204 indicates the presence of an object (e.g. of a particular class) in the frame.

Accordingly, a subset of the frames (in this example one in every three frames) may be sent to be analysed by the object detection node 204, resulting in a processed frame with object detection metadata being output from the system 200, while the other two of every three frames result in a null output from the system 200 indicating that the result of the processing of the frame by the graph has no value. This provides a particularly efficient method for performing object detection, in an example where it is desired to only analyse a subset of the frames. Since only the frames to be analysed are received by the objection detection node 204 the object detection node 204 does no image processing in respect of frames which are not to be analysed and only handles passing a null to its output. This can be contrasted with other arrangements in which each of the frames in a stream of images is transmitted to the object detection module 204 with the arrangement relying on the object detection module 204 to determine whether or not to process a frame, e.g. with an imperative programming instruction which causes the object detector to apply the object detection process to one out of every three frames while not applying the object detection process in the other two out of three frames.

Example systems, as illustrated by the example of FIG. 2, allow for easy modification of the processing to be applied to frames by rearranging nodes, or, for example, by modifying the control condition to be applied by a control node, or adding one or more further control nodes to guide frames through the graph in a different manner. For example, in the system 200, the control condition of the control node 202 may be easily modified without modifying the object detection module 204. Furthermore, since the structure of the system 200 is modular, the object detection module 204 may be easily substituted with another object detection module, for example an object detection module configured to run on different hardware, without changing the general function and structure of the graph 200.

FIG. 3 shows another image processing system 300 comprising a graph 300 comprising a different arrangement of nodes to the image processing system 200 of FIG. 2.

The system 300 of FIG. 3, in addition to an input node 310, and an output node 320, which operate in the same manner as described for the previous example, comprises a first compute node 302, a first control node 304 and a second compute node 306. In this particular example, the first compute node 302 is an object detection node 302, which may be similar to the compute node 204 described above with reference to FIG. 2. The object detection node 302 receives frames from the input 310 and applies an object detection model to the frames. The object detection node 302 outputs each frame it processes in combination with metadata indicative of objects detected in the frame to the control node 304. In this example, the control node 304 is configured to determine from the frame and metadata received from the object detection node 302, for each particular frame, whether a person is shown the frame. If a person is shown in frame, then the control node 304 outputs the frame and metadata received from the object detection node 302 to the second compute node 306. The second compute node 306 is a facial recognition node 306. The facial recognition node 306, from the control node 304, frames processed by the object detection node 302 in which the object detection node 302 has detected the presence of one or more persons. The facial recognition node 306 applies a facial recognition operation, e.g. employing a trained neural network model, to the received frame resulting in further metadata indicative of the result of the facial recognition process which is appended to the processed frame. The facial recognition node 306 then transmits the resulting processed frame plus metadata to the output node 320 where it is output from the system 300.

For frames where the object detection node 302 does not detect a person, the control node 304 determines that a particular processed frame it receives from the object detection node 302 does not show a person, e.g. by inspecting the metadata appended to the frame by the object detection node 302 (or noting the lack of any metadata indicating one or more detected persons), and the control node 304 outputs a null to the facial recognition node 306. The facial recognition node 306, on receiving a null, forwards the null to its output and does not apply the facial recognition model in respect of the particular frame being processed.

Accordingly, facial recognition is only applied to frames in which a person is detected by the object detection node 302. The facial recognition node 306 does not see frames which have been determined not to show a person, and therefore computation involved in processing such frames with the facial detection model is avoided, and this is achieved in a modular way which does not require the facial recognition node 306 to make any determination of the presence of lack thereof of a person in a particular frame.

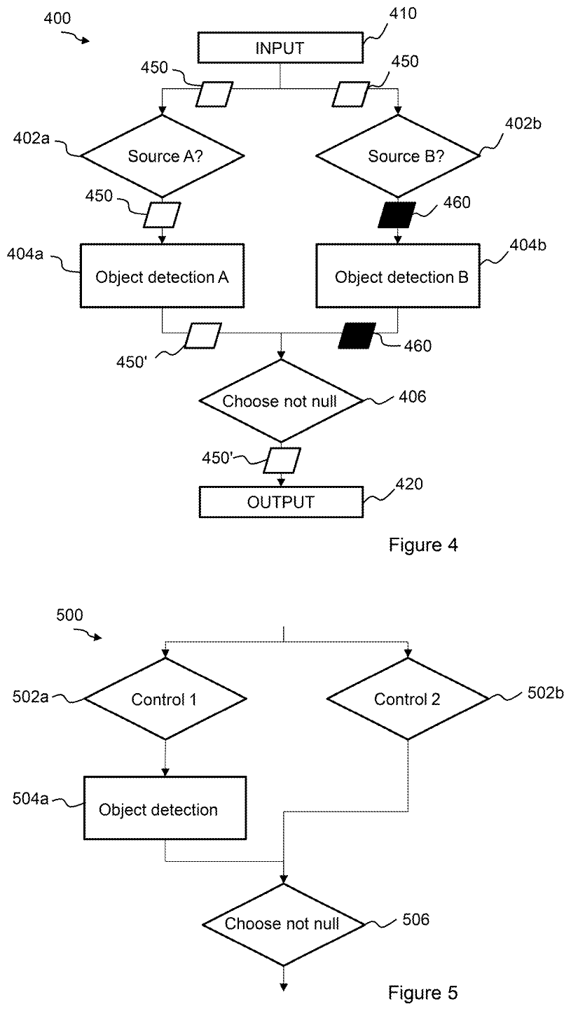

FIG. 4 shows another example image processing system 400 comprising a graph 400 of nodes, again comprising an input node 410 and an output node 420 which operate as described with reference to previous examples. The graph 400 of FIG. 4 comprises a plurality of control nodes as well as a plurality of compute nodes.

In this example, the graph 400 is configured to receive at the input 410 two different streams of image frames, which, in this example, original from two different sources, referred to in this example as Source A and Source B. The two different sources may, for example, be two different cameras capturing different video streams. The present example allows for each of the two streams to be processed by the graph 400 in a different manner. An example of one particular frame, a first frame 450, being processed by the graph 400 is shown in FIG. 4.

The first frame 450, in this example, is a frame from Source A. In this example, each frame which arrives at the input 410 comprises an identifier, e.g. in the from of metadata, which indicates the source from which the frame originates, e.g. Source A or Source B. The graph 400 is structured such that frames from Source A are directed to one part of the graph 400 while frames from Source B are directed to another part of the graph 400, in the following manner.

The frame 450 having arrived at the input node 410 is transmitted by the input node 410 to a first control node 402a and to a second control node 402b. The first control node 402a is configured to determine, e.g. from source identifying metadata appended to the frame, if each frame it receives derives from Source A, and, if so, to transmit the frame to a first compute node 404a. If the first control node 402a determines that a frame it receives is not from Source A, then the first control node 402a is configured to transmit a null to the first compute node 404a. In the example shown in FIG. 4, the first frame 450 is from Source A, and therefore the first control node 402a transmits the first frame 450 to the first compute node 404a.

The second control node 402b operates in a similar manner to the first control node 402a, except the second control node 402b is configured, if it determines that a frame it receives is from Source B, to transmit the frame to a second compute node 404b, and if it determines that the frame is not from Source B, (e.g. in this example, it determines that the frame is from Source A) to transmit a null to the second compute node 404b. In this example, since the frame 450 is from Source A, the second control node 402b transmits a null 460 to the second compute node 404b.

In this example, the first compute node 404a is a first object detection node 404a and the second compute node 404b is a second object detection node 404b. The first and second object detection nodes may, for example, be configured to apply different object detection models to one another. For example, the first object detection node 404a may apply a model trained to recognize certain types of object, e.g. persons, while the second object detection node may apply a different object detection model more suited to detecting other types of object, e.g. chairs. The particular type of computation applied to the different streams may, for example, depend on the context of the images from the different sources, Source A and Source B. For example, security or privacy considerations may be such that it is desired or permitted to apply facial recognition to images from one of the sources but not to images from the other of the sources. In another example, the object detection models applied at the object detection nodes 404a, 404b may, for example be run on different hardware.

In the example shown in FIG. 4, the first frame 450, since it derives from Source A, is received by the first object detection node 404a which applies its object detection model to the frame 450 and outputs a processed frame 450′ which, in the manner described above for other examples, may comprise the frame 450 in combination with metadata indicative of the result of the object detection applied at the object detection node 404a.

On the other hand, the second object detection node 404b receives the null 460 and therefore, in respect of the first frame 450, performs no object detection processing. The second object detection node 404b outputs the null 460.

In this example, the outputs of the first object detection node 404a and the second object detection node 404b are transmitted to a third control node 406. The third control node 406 is configured to select from the inputs it receives from the object detection nodes 404a, 404b, system 400 and to output the selection. In this example, the third control node 406 is configured to select the input which is not a null. Accordingly, in this particular example, on receiving the processed frame 450′ and the null 460, the third control node 406 selects and outputs the processed frame 450′. The processed frame 450′ is then output at the output node 420 as the result of the processing of the frame 450 by the graph 400. Although this particular example has been described with reference to a particular frame 450 deriving from Source A, it will be appreciated that in another example where the frame being processed derives from Source B, the output of the graph 400 will be a processed frame which has been processed by the second object detection node 404b (and not by the first object detection node 404a).

From the above discussion, it can be seen that certain examples, such as that shown in FIG. 4, provide for a system which guides frames received at an input to different portions of the graph depending on characteristics of each received frame.

It can be seen that various arrangements of nodes, including one or more control nodes and/or one or more compute nodes can thereby be provided to perform a desired image processing operation, or a desired set of image processing operations, on a given frame.

FIG. 5 shows one arrangement 500 of nodes according to an example which may be employed in various examples of an image processing system according to the present disclosure. The arrangement 500 shown in FIG. 5 comprises a first control node 502a, a second control node 502b, a compute node 504a and a third control node 506. The arrangement 500 of FIG. 5 provides for a similar operation to the example described above with reference to FIG. 2 wherein the image processing system is configured to apply object detection to only a subset of received frames. In one particular example described with reference of FIG. 2, for every third frame, the system 100 outputs a frame with appended metadata indicative of the result of object detection, while for every other frame a null is output. In the example shown in FIG. 5, the first control node 502a may operate like the control node 102 shown in FIG. 2 and transmits every third frame to the object detection node 504a and for every other node transmits a null to the object detection node 504a. The second control node 502b, for the one in three frames transmitted by the first control node 502a, transmits a null to its output and for the other two in three frames transmits the frame. The third control node 506 receives the outputs from the object detection node 504a and from the second control node 502b. In a similar manner to as described for FIG. 4, the third control node 506 selects, from the inputs it receives, the input which is not a null, and outputs that input.

As such, the output from the third control node 506, and therefore from the arrangement of nodes 500 in FIG. 5, is: for every third frame, a processed frame comprising the frame with appended metadata indicating the result of the object detection; and, for the other two in three frames, is the frame as received by the control nodes 502a, 502b. This allows for a subset of frames (in this example, two out of three frames) to be passed through the arrangement 500 without applying object detection thereto, while allowing the output of the arrangement to comprise all of the received frames, i.e. outputting the frame as received at the control nodes 502a, 502b frame, rather than a null. It will be appreciated that an arrangement such as that shown in FIG. 5 may be employed at various positions in an example system. For example, the input into the arrangement 500 may already have passed through various other control and/or compute nodes. Further the output from the arrangement may be passed directly to the output node or may be transmitted to further nodes in the graph which may guide the processed frame to other nodes and/or perform other image processing operations on the frame.

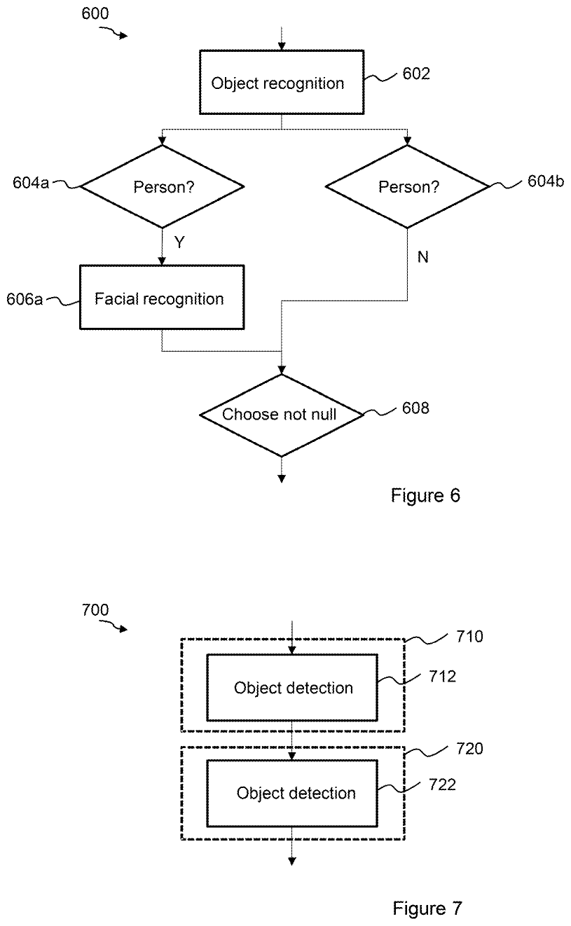

Another example of an arrangement of nodes 600, which may be employed in image processing systems according to examples, is shown in FIG. 6. In FIG. 6, a first compute node 602 is configured to perform object recognition on each frame it receives. The output of the object recognition node 602 is transmitted to a first control node 604a which is configured to determine if a person has been detected in the frame and if so to transmit the processed frame to a facial recognition node 606a and if not to transmit a null to the facial recognition node 606a. An output of the facial recognition node 606a is transmitted to a third control node 608. A second control node 604b is configured to transmit processed a frame received from object recognition node 602 to the third control node 608 if the second control node 604b detects that the frame does not show a person. If the second control node 604b determines that a processed frame received from the object recognition node 602 shows a person, then the second control node 604b transmits a null to the third control node 608. The third control node 608 is configured to select the input which is not a null and to output transmit this input. Accordingly, an arrangement is provided in which frames are only transmitted to have facial recognition performed on them if the frame has been determined to show a person. Otherwise, the frame is passed to the output without being transmitted to the facial recognition node 606a. Similarly to the arrangement of FIG. 5, this allows for frames in which no persons have been detected to be passed through the arrangement without being processed by the facial recognition node 606a while for each frame input to the arrangement a modified frame or the original frame is output.

In some examples, processing of frames by image processing systems according to examples may be performed concurrently. For example, FIG. 7 shows an arrangement of nodes 700 comprising a first block 710 and a second block 720. The first block 710 and the second block 720 may process two different frames in an image stream concurrently. For example, a first frame may be processed by the first block 710 and, once processing by the first block 710 is complete, passed to the second block 720 to be processed by the second block 720. While the second block 720 is processing the first frame, the first block 710 may begin processing a second frame. Each of the blocks 710, 720, in this example, is shown comprising a single respective object detection node 712, 722 for processing image frames. However, in other examples, any number of nodes may be present in the blocks 710, 720 and in other examples any other number of blocks may operate concurrently in this manner. This provides for efficient processing of a stream of image frames since once a block has completed processing of a given frame, the block may begin processing a subsequent frame while the previous frame is processed by a block further towards the output of the graph, as opposed to the system processing a received frame completely before moving onto the next frame.

FIG. 8 shows an example of a computing system 800, in which an image processing system according to examples described above may be implemented.

The computing system 800 comprises an image processing apparatus 810, which operates an image processing system which may be according to any of the examples described above. The apparatus 810 is configured to receive images from a camera 820, which may for example transmit the images over a network connection or a direct connection to one or more other apparatuses (not shown). In this example, the apparatus 810 is configured to receive a stream of images, in the form of a video stream, from the camera 820. In some examples, the apparatus 810 may receive images from one or more further sources of images, e.g. a second camera.

The apparatus 810 is configured to process the images received from the camera 820, by use of an example image processing system. The apparatus 810 may output a result of the processing to one or more other apparatuses, e.g. via a suitable network connection such as a connection to a local area network or a wide area network, such as the internet. For example, results of the image processing performed by the image processing apparatus 810 may be output for storage by another apparatus or to undergo further processing by another apparatus. The result of the processing of the image may, for example, comprise the image in combination with data indicating a result of the processing of the image.

FIG. 9 shows an image processing apparatus 910 for processing a stream of images, e.g. a video stream, according to an example. The apparatus 910 may, for example, be employed in a computing system such as that shown in FIG. 8. The apparatus 910 comprises a processing unit 912, a memory 914, and input interface 916 and an output interface 918. The apparatus 910 may be, for example, a Raspberry Pi (ID or NVIDIA® Jetson Nano™ Developer Kit processing device. The apparatus 910 is configured to implement an image processing system according to any of the examples described above with reference to FIGS. 1 to 7. In some examples, the memory 914 stores a computer program comprising instructions which, when executed by the processing unit 912 cause the processing unit 912 to implement an image processing system according to any of the examples described above. In one example, the processing unit 912 is configured to receive, via the input interface 916, a stream of images from a camera 820, e.g. over a network, and to process the received images by use of an image processing system as described in any of the above-described examples.

As will be appreciated by one skilled in the art, examples according to the present disclosure may be embodied as a system, method or computer program product. Examples according to the present disclosure may take the form of a computer program product tangibly embodied in a non-transient computer readable medium having computer readable program code embodied thereon. A computer readable medium may be, for example, but is not limited to, an electronic, magnetic, optical, electromagnetic, infrared, or semiconductor system, apparatus, or device, or any suitable combination of the foregoing.

Computer program code for carrying out operations of examples of methods according to the present disclosure may be written in any combination of one or more programming languages, including object-oriented programming languages and conventional procedural programming languages. For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

In one alternative, an example method according to the present disclosure may be realized in the form of a computer implemented method of deploying a service comprising steps of deploying computer program code operable to, when deployed into a computer infrastructure or network and executed thereon, cause the computer system or network to perform all the steps of the method.

In a further alternative, an example according to the present disclosure may be realized in the form of a data carrier having functional data thereon, the functional data comprising functional computer data structures to, when loaded into a computer system or network and operated upon thereby, enable the computer system to perform all the steps of the method.

Whilst in certain examples described above the image processing system comprising the graph of nodes is implemented by a single computing entity, e.g. a single image processing device, in some examples the graph may be distributed over multiple computing entities in communication with one another. For example, an image processing system according to certain examples may be distributed over one or more physical devices, and/or distributed over one or more processes, containers, or virtual machines which operate on a single device or which are distributed over a plurality of devices. In such examples, each of a plurality of computing entities over which the graph is distributed may implement one node or more than one node. In some examples, nodes of graph may be divided into groups, and each group of nodes may operate on a separate entity. For example, certain nodes, such as certain control nodes, may be computationally trivial and may be grouped with one or more other nodes to be implemented by a particular computing entity. Certain other entities may implement only one node. In examples where the nodes of the graph are distributed in the above manner, the graph may be put into operation by a computer program, e.g. a distributed program, which implements and manages the operation of such a system of distributed entities.

The above examples are to be understood as illustrative examples of the invention. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

1: A computer implemented method of processing image data by an image processing system comprising a directed acyclic graph of nodes for receiving and processing image data, the method comprising:
at a compute node in the graph: receiving image data; performing an image processing operation on the image data to produce a compute node output based on the image data; and transmitting the compute node output to another node in the graph; and
at a control node in the graph: receiving a control node input, wherein the control node input is the image data or is based on the image data; and, if the control node determines that a control condition is satisfied, transmitting the control node input to another node in the graph.

2: The method of claim 1, wherein the image data are data defining an image frame.

3: The method of claim 2, wherein the system is for processing a stream of image frames, and wherein the image frame is one of the stream of image frames.

4: The method of claim 1, comprising:
at the control node, transmitting an indicator indicative that the control condition was not satisfied to the other node in the graph if the control condition is not satisfied.

5: The method of claim 1, wherein the compute node output comprises the image data in combination with data indicative of a result of the image processing operation performed on the image data.

6: The method of claim 1, wherein the image processing operation performed by the compute node comprises analysing the image data to determine one or more characteristics of the image data.

7: The method of claim 6, wherein the analysing the compute node input comprises applying a trained model to the image data to detect one or more features and/or recognise one or more objects of a scene represented by the content of the image data.

8: The method of claim 7, wherein the trained model comprises a neural network.

9: The method of claim 1, wherein the image data define an image frame and wherein the image processing operation is an image manipulation operation to be performed on the image frame, such as a resizing operation or a cropping operation.

10: The method of claim 1, wherein the control condition is determined based on a characteristic of the image data or a characteristic of the compute node output.

11: The method of claim 10, wherein the control condition is determined based on one or more of:
a source identifier identifying a source of the image data; and
where the image data define an image frame in a stream of image frames, a position of the image frame in the stream of image frames.

12: The method of claim 1, wherein the other node to which the control node transmits the control node output if the control condition is satisfied is one or more of:
the compute node and/or another compute node;
another control node; and
an output node configured to output image processing data from the graph.

13: The method of claim 1, wherein the other node to which the compute node transmits the compute node output is one or more of:
another compute node;
the control node and/or another control node; and
an output node configured to output image processing data from the graph.

14: The method of claim 1, wherein the control node input is the image data and wherein the other node, to which the control node transmits the control node input if the control condition is satisfied, is the compute node.

15: The method of claim 14, comprising:
at a second compute node in the graph:
receiving the compute node output based on the image data as a second compute node input;
performing an image processing operation on the second compute node input to produce a second compute node output based on the image data; and
transmitting the second compute node output to another node in the graph.

16: The method of claim 15, comprising:
at the control node:
receiving the compute node output as the control node input; and
transmitting the compute node output to the second compute node as the second compute node input if the control condition is satisfied.

17-20. (canceled)

21: The method according to claim 1, wherein the image data is first image data and the method performed by the system comprises processing second image concurrently with the first image data.

22: The method according to claim 21, wherein the concurrent processing comprises processing the first image data by one of the nodes of the graph concurrently with processing the second image data by another node of the graph.

23: A computer implemented image processing system for processing image data, the system comprising a directed acyclic graph of nodes configured to receive image data and to process the image data, the directed acyclic graph of nodes comprising:
a compute node configured to receive the image data, to perform an image processing operation on the image data to produce a compute node output based on the image data, and to transmit the compute node output to another node in the graph; and
a control node configured to receive a control node input, wherein the control node input is the image data or is based on the image data, and to transmit the control node input to another node in the graph if a control condition is satisfied.

24: A computer implemented image processing system for processing image data, the system comprising a directed graph of nodes configured to process image data by passing the image data through the graph, the graph comprising:
one or more compute nodes, each compute node configured to perform a respective image processing operation on image data received by the respective compute node and to output processed image data based on the image processing operation; and
one or more control nodes, each control node configured to direct image data or processed image data received by the respective control node to one or more other nodes in the graph based on a respective control condition.

25-26. (canceled)
